(19) United States
(12) Patent Application Publication
(10) Pub. No.: US 2009/0030980 A1
(43) Pub. Date: Jan. 29, 2009

(54) UNIVERSAL INSTANT MESSAGING SYSTEM FOR THE INTERNET

(76) Inventors: Kevin Remington Joseph Donovan, White Plaines, NY (US); Peter K. Trzyna, Chicago, IL (US)

Correspondence Address: PETER K. TRZYNA, ESQ., P O BOX 7131, CHICAGO, IL, 60680, US

(21) Appl. No.: 11/781,813

(22) Filed: Jul. 23, 2007

(51) Int. Cl. G06F 15/16

(52) U.S. Cl. 709/204

(57) ABSTRACT

Two or more users with PCs or similar devices to access the Internet may establish a connection between each other for instant messaging, even when the users are associated with different realms. For this purpose, the PCs are provided with an IM manager which oversees the instant messaging sessions. In addition, an IM server is provided associated either with a particular SP (service provider), or alternatively, having its own PS. The IM server is used to keep track of all the active users that have registered for the IM service and their corresponding current IP address. The IM manager includes a database which stores protocols of foreign realms. When a user requests an instant messaging session, his PC establishes the connection to the other user based on the protocol of the other user's realm and the other user's current IP address indicated by the IM database.

### I. PRIORITY DATA

This patent application claims priority from and is incorporates by reference U.S. patent application Ser. No. 09/385,802 filed by the same inventor on Aug. 30, 1999, and incorporates by reference U.S. patent application Ser. No. 11/159,714, titled INTERNET TELEPHONE SYSTEM that was filed on Jun. 23, 2005.

### II. BACKGROUND OF THE INVENTION

A. Field of Invention

This invention pertains to an apparatus for providing instant messaging (IM) on and through the Internet across various platforms. More particularly, the invention pertains to a system which allows individuals to exchange messages and files over the Internet substantially instantaneously across multiple and different protocols and systems.

B. Description of the Prior Art

Since the infancy of the Internet, various functions and protocols have been developed which allow users not only to view and gather a variety of information from Internet host computers, such as through Telnet, Gopher, FTP, and HTTP (the protocol for the World Wide Web), but also to exchange messages via e-mail services. One disadvantage of the latter is that the transmission time of any e-mail message is unpredictable and therefore it is difficult for two or more users to exchange messages instantaneously. In order to overcome this problem, software protocols and session managers (each, an IM platform) have been developed by service providers (SPs), whether they be an Internet or online general access provider such as America Online (AOL) or an portal instant messaging provider such as Yahoo! (Yahoo), which allow two users of an SP's IM platform to communicate with each other instantaneously provided both users are using the same IM platform. However, none of these existing systems allow a user to communicate with another user of a different SP's IM platform. Since there are millions of users all over the world who receive Internet services from different local providers based on price, characteristics of the services, personal preferences and other criteria, many users cannot take advantage of instant messaging if they do not utilize the same IM platform.

### III. OBJECTIVES AND SUMMARY OF THE INVENTION

It is an objective of the present invention to provide a system that provides instant messaging between multiple IM platforms.

A further objective is to provide an instant messaging system that is capable of exchanging not only text files but also voice communication and other types of exchanges.

Yet a further objective is to provide a system in which a peer-to-peer connection is established between users thereby bypassing the SP.

Other objectives and advantages of the invention will become apparent from the following description of the invention.

Briefly, two users who are using different IM platforms (a user of an IM platform is said to be in that IM platform's realm) can participate in an instant messaging session as follows. Each user accesses the Internet via a PC. (The term PC is used for a desktop computer, a laptop computer, a palmtop computer, a Web TV device or any other similar device that can be used to access the Internet). The PC is provided with IM session manager 10 software (an IM manager) which is used to establish and monitor each IM session including receiving and responding to commands from the user related to the instant messaging function and displaying information to the user related to the IM function. The IM session manager includes an internal database used to store the protocols for different realms. A PC is able to establish an instant messaging Session with a user from another realm if its database includes the protocol for that realm.

In addition, an IM database is also provided. This database is used to register all the users who are interested in using IM and to store information for each user, such as his name, his Internet address, his realm, and so on. Importantly this IM database is also used to generate and maintain a list of all the registered users who are active, i.e., online, at any particular moment, together with each user's current 12 address. Each time a registered user signs onto the Internet, his IM manager automatically sends the PCs current 12 address so that the IM databases compile its list. When a user signs off the Internet, the list is again edited to show this change.

The IM database can be incorporated into the server of a SP or can be part of an independent server connected to the Internet. In the first implementation, the SP can control access to the IM function while in the second implementation the IM function is open to all users.

Preferably when a user accesses the Internet, a window is displayed on his screen showing an active friends list (i.e., the friends from his list who are online) which is a subset of the active users in the IM database. That user can then initiate an instant messaging session with one or more friends on this list and exchange messages or other data.

### IV. BRIEF DESCRIPTION OF THE DRAWINGS

FIG. 1 shows a simplified block diagram showing the interconnection between three users;

FIG. 2 shows a block diagram of a system allowing universal instant messaging between two users;

FIG. 3 shows a flow chart illustrating the process used to establish the universal instant messaging connection in a closed network implementation of the subject universal instant messaging system;

FIG. 4 shows a flow chart illustrating a portion the process used to establish the universal instant messaging connection in an open Web implementation of the subject universal instant messaging system; and

FIG. 5 shows a typical window or windows displayed to a user while he is engaged in exchanging messages using the subject universal instant messaging system.

### V. DETAILED DESCRIPTION OF THE SYSTEM

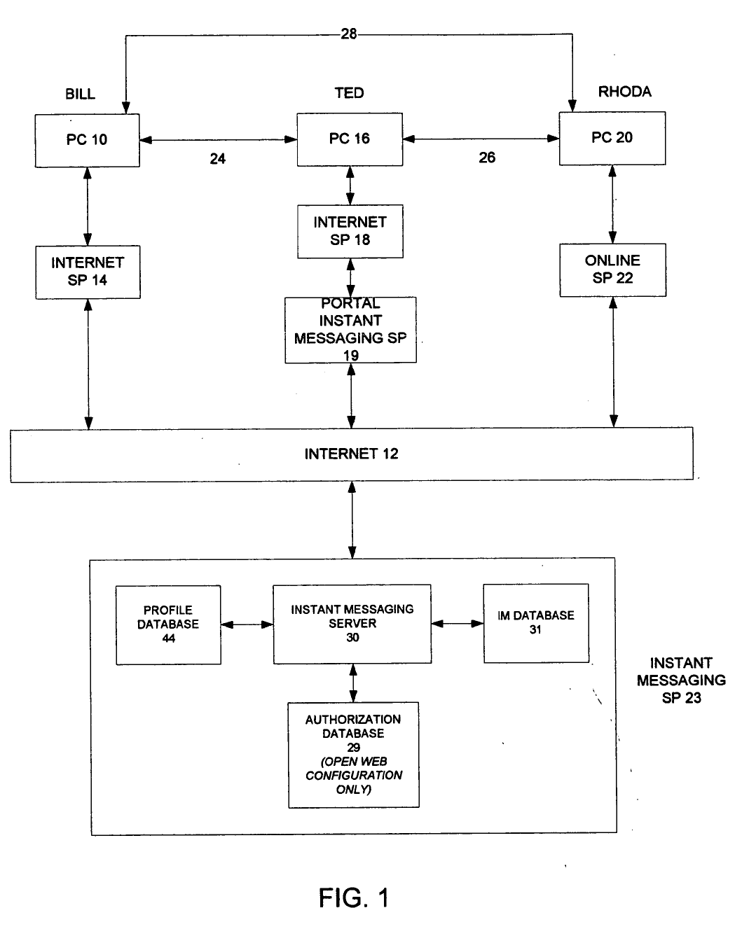

Referring first to FIG. 1, the purpose of the present invention is to allow an Internet user to communicate with multiple other Internet users instantaneously even if they are connected to the Internet through different SPs and/or belong to different domains or realms than the User. Of course, each user communicates with his or her SP by using a communication device such as a desktop computer, a laptop computer, a handheld computer, or similar computer device, which for the purposes of this invention will be referred to generically as a PC, it being understood that a PC is meant to cover any appropriate device suitable for this purpose.

In FIG. 1, three different users are shown who belong to different realms. More particularly, Bill is associated with Prodigy, Ted is associated with Yahoo and Rhoda is associated with AOL. Bill is connected to the Internet 12 by a SP 14 through his PC 10, which in his case is Prodigy. Ted with PC 16 is connected to the Internet 12 by a different SF 18 and through the SF 18 is connected a portal instant messaging SF provider 19 that in his case is Yahoo. Rhoda is connected to the Internet 12 with her PC 20 by a third SP 22 that in her case is AOL. The present invention allows these three (or any other users having appropriate equipment/software) to be connected to each other by connections 24, 26, 28, which may be, for instance, peer-to-peer connections. These connections are established by an instant messaging SP 23. Once these connections are established, instant messaging sessions are generated to allow the users Bill, Ted, and Rhoda to communicate to each other by exchanging text files, or by voice if their equipment is capable of this function. Individual instant messaging sessions may be generated between each pair of users, or alternatively conferencing may be allowed where three or more users can exchange messages during a single instant messaging session. Details of how the instant messaging sessions between users of different realms are established and how the system operates are provided below.

The instant messaging SP 23 includes an IM server 30, an IM database 31, an authorization database 29 used to identify each user connecting to the iM server 30 and to determine if the user should be allowed access, and a profile database 44 which contains characteristics of the users serviced by instant messaging SP 23. The IM SP 23 performs two functions. First, all users interested in using the IM service register with the IM SP 23. During this registration process, each user provides his name, Internet address and/or other information. Second, the IM SP 23 tracks all the registered users who are currently on the Internet. That is, IM database 31 includes a list of all current users presently on line, together with their IP address. If users Ted, Bill and Rhoda are on line at a particular time, their name is on this list. IM SP 23 and its databases and other components are shown in FIG. 1 as separate elements with a dedicated connection to the Internet (an open Web implementation). It should be understood, however, that these elements (except for database 29) might be incorporated into a standard SP, such as SP 14, as well, and in this case access to the IM service may be limited to the users of that particular SP (a closed network implementation).

Each user generates a list of users (who must also be registered) that he can contact if he and the other users are on line at the same time. For the sake of simplicity this list is referred to as a list of friends. The list of friends may be divided into several categories using any combination of criteria such as business, social or personal connections, geographic locations, realms, and so on. As described in more detail, an active friends list is generated from a user's list of friends which consists of all the friends who are on line at that particular instant.

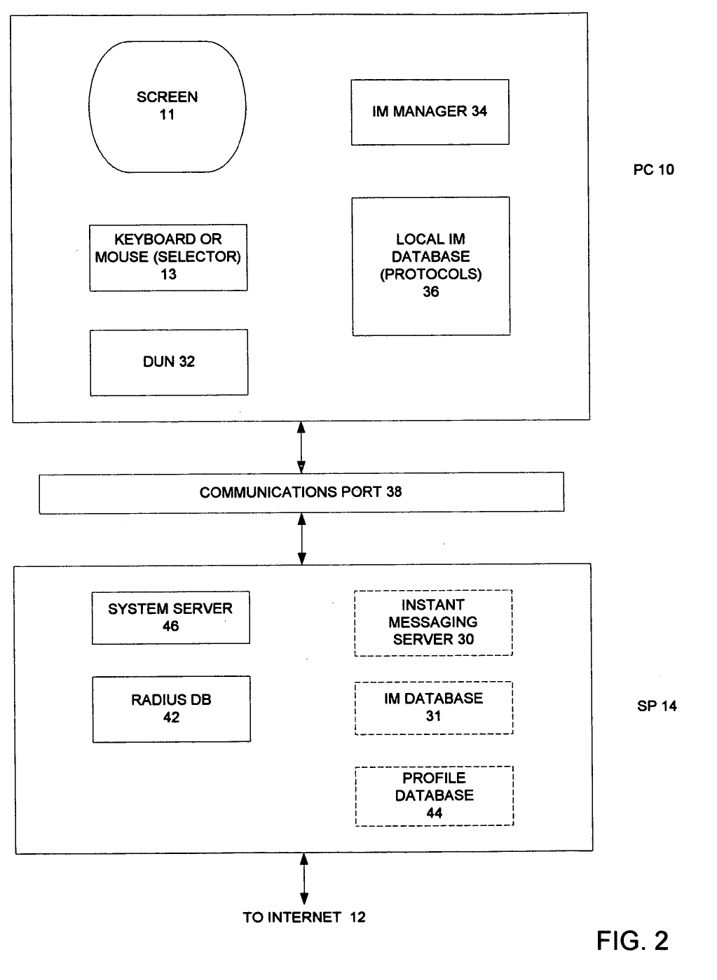

Referring now to FIG. 2, typically, PC 10 includes several components which enable it to connect to the SP 14 and perform standard Internet functions, including dial-up networking (DUN) 32, and an instant messaging (IM) session manager 34 and a database 36 which contains a plurality of protocols used by various SPs or realms, e.g., Yahoo, AOL, etc. which are available for the instant messaging function. The PC 10 is also provided with a screen 11 used to present various text and images to the user and a selector such as a keyboard, a mouse, or other input device 13 on which the user enters commands and information in the usual manner.

The PC 10 communicates with its SP 14 through a communication port 38 that may be standard telephone modem, or any other equivalent device. The SF 14 includes a system server 46, and a radius database 42 which cooperate to provide a standard Internet service to Bill. In the open Web implementation as shown in FIG. 1, the PC 10 communicates directly with the service provider 14, and through the SP 14 communicates with the instant messaging SF 23 via the Internet 12.

In the closed network implementation, the SF 14 further includes the IM server 30 which performs the data processing required for instant messaging, and the IM database 31. The function of the authorization database 29 is performed by another component such as RADIUS data base 42 used to identify each user connecting to SF 14 and to determine if the user should be allowed access. The profile database 44 which contains characteristics of the users serviced by SF 14 is also incorporated into the SP 14.

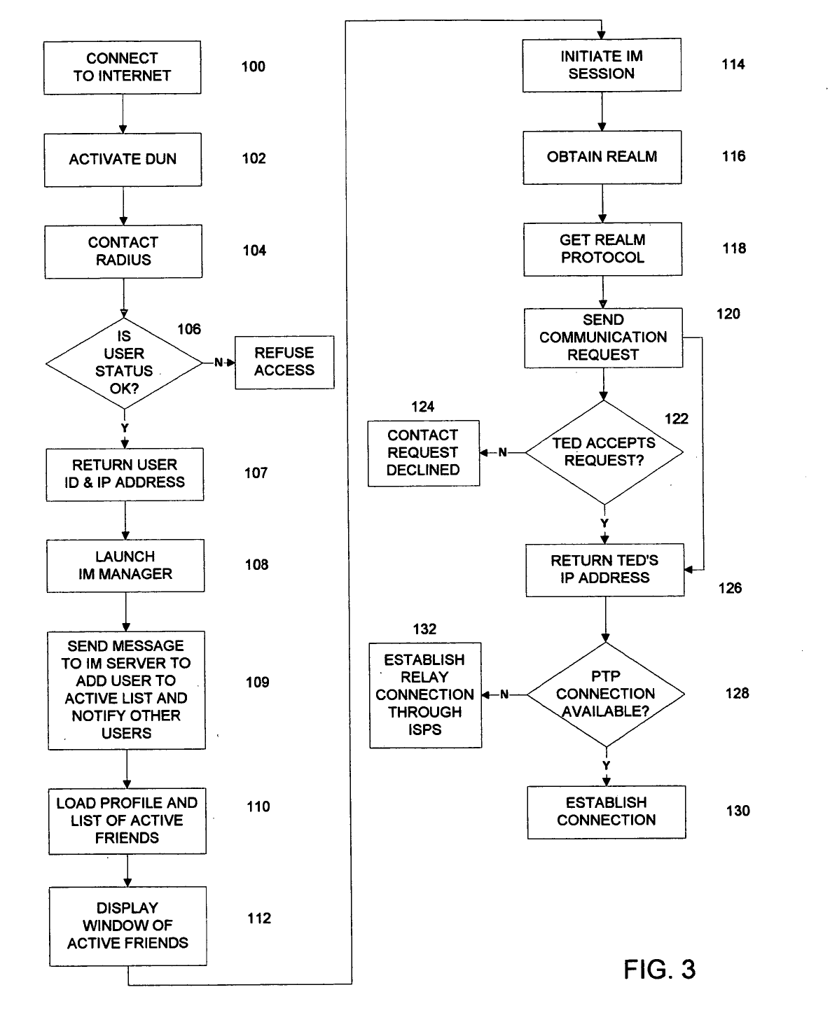

The operation of the system 10 is now described for the closed network implementation, in conjunction with FIG. 3.

In step 100 Bill issues a command to his PC 10 to establish a connection to the Internet 12. In response, in step 102 the PC 10 activates the DUN component 32 that attempts to connect to the SP 14 using a standard protocol such as PPP. In order to gain access, the DUN component 32 sends the user's ID and password to the SF 14's authorization database 42 (step 104). The authorization database 42 checks if Bill is a current and valid user of the SF and verifies the user ID and password. If the user ID and password are correct and Bill's account is active, the DUN connection is verified and Bill will have access through the SP 14 (step 106). If for any reason Bill's status is unacceptable, access to the SP 14 and, through the SP 14, to the IM server 30 is refused.

If Bill is granted access through the SP 14, the IM database 42 provides a user ID to the IM server 30 together with his current IP address (step 107). In step 108, Bill launches the IM manager 34, which must be launched in order to create a direct connection to the IM server 30.

During step 109 the IM manager 34 on Bill's PC contacts the IM server 30 to indicate that Bill is on-line and registered for IM functionality. The server 30 then adds Bill's user ID to the list of active IM users (i.e., users who are currently online). The IM server 30 will also notify the IM managers of users who have added Bill to their own friends list and who are online at this time that Bill has established an active connection to the IM server 30.

During step 110 the IM server 30 returns to Bill's IM manager 34 Bill's profile from database 44. This profile includes Bill's ‘persona’ information such as his Internet name and address, various preferences and other data such as his list of fiends generated previously by Bill, as discussed above. The IM server will also send to the IM manager 34 an active list of which users on Bill's friends list are currently online, and the IM manager 34 will indicate all such users in Bill's active list as being online. Alternatively, the IM server 30 may collate a cross-referencing table indicating which of the users are on other users' friends list. In this manner, when IM server 30 receives a message that Bill is signing on, the server 30 can check all active users and generate Bill's active list from the table.

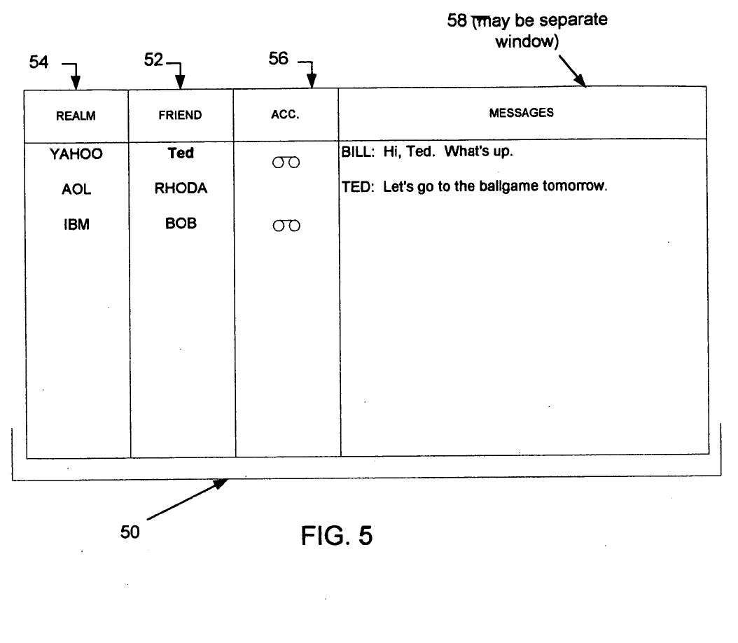

When the PC 10 receives this information, in step 112 the IM manager 34 displays a window indicating Bill's active Mends list. In the closed network configuration, the PC may also display a standard welcome screen that is generally characteristic of the SP 14. For example, as shown in FIG. 5, such a window 50 may include a column 52 for the name of each friend in the user's friends list, with a second column 54 with an indication of each friend's realm The column 52 may indicate in some fashion which of the people listed in the friends list are currently active, i.e., online. In FIG. 5, the window 50 indicates that a person appearing in the column 52 containing that user's friends list is active by placing that person's name in boldface and lower case.

The window 50 may also provide additional columns showing other information. In FIG. 5, the window 50 shows a column 56 indicating whether or not each active friend is capable of using some specific Internet function such as an Internet telephone. In the example shown in FIG. 5, Ted and Bob have this capability wile Rhoda does not. Finally, window 50 may have a separate area 58 dedicated for messages, or a message area 58 may exist in a separate window. In the preferred embodiment, the window 50 is displayed automatically together with the welcome screen and can be turned off or made dormant (e.g., minimized on the screen) by Bill at will.

Once the welcome screen is displayed, Bill can communicate with any of his friends from the active list shown in window 50 through the message area 58. As mentioned above, prior to the present invention, instant messaging was available only between users of the same realm or SP. However, in the present system instant messaging is available even though Bill and Ted are users in different realms.

In order to initiate an instant message, in step 114, Bill clicks on Ted's name in window. In response, in step 116 the IM manager 34 obtains the protocol for Ted's realm (in this case Yahoo, a portal instant messaging service provider). In step 118, the IM manager 34 retrieves the foreign realm protocol from database 36.

In step 120 the IM manager 34 sends a message to SP 18 using Ted's current IP address obtained from IM server 30 requesting a connection with Ted's IM manager. Depending on SP 18, this message may result in the SP 18 displaying to Ted a window indicating that Bill wants to contact him via the IM system. In this case, in step 122 Ted is given the choice of either accepting the connection request or declining it. If Ted declines the connection request, then in step 124 a message is sent back by SP 18 to Bill that Ted has declined the connection request. As part of step 120, in order to access a foreign realm such as Yahoo, Bill may need to supply a user ID and password for that realm during the process by which the IM manager 34 establishes a peer-to-peer connection with that realm. The IM manager 34 may include the ability to store such user IDs and passwords for each foreign realm for which a protocol is stored in database 36 so that the user will not be prompted to enter them each time that user wishes to communicate with a user in another realm.

If in step 122 Ted accepts the connection request or if the SP 18 did not require that a message be sent to Ted, thereby skipping step 122, then in step 126 server 18 sends a message to Bill indicating Ted's current 12 address. If necessary, this preliminary exchange may include an encryption key to allow the communications between Ted and Bill to be encrypted using any standard security protocol. As indicated above, the process can be performed without actually requiring Ted to expressly accept the contact request, in which case step 126 follows step 120 directly.

In step 126, the IM manager 34 then can set up a direct connection 24 between Ted and Bill. This connection may be a peer-to-peer connection, and is termed a ‘direct’ connection to indicate that. Although messages exchanged through this connection are still sent over the Internet, they are transparent to and are not seen by the servers 14 or 18.

In step 128 the IM manager 34 determines if a direct or peer-to-peer connection between Bill and Ted's PCs is available. If it is then the peer-to-peer connection 24 is established in step 130 and Bill and Ted can send each other text messages, they can talk to each other via the telephone (using for instance streamlining) and can exchange files with images, video- and sound-clips, documents, and so on. If a peer-to-peer connection is not available, then in step 132 a relay connection is established between the servers of SPs 14 and 18 to allow the users to exchange messages.

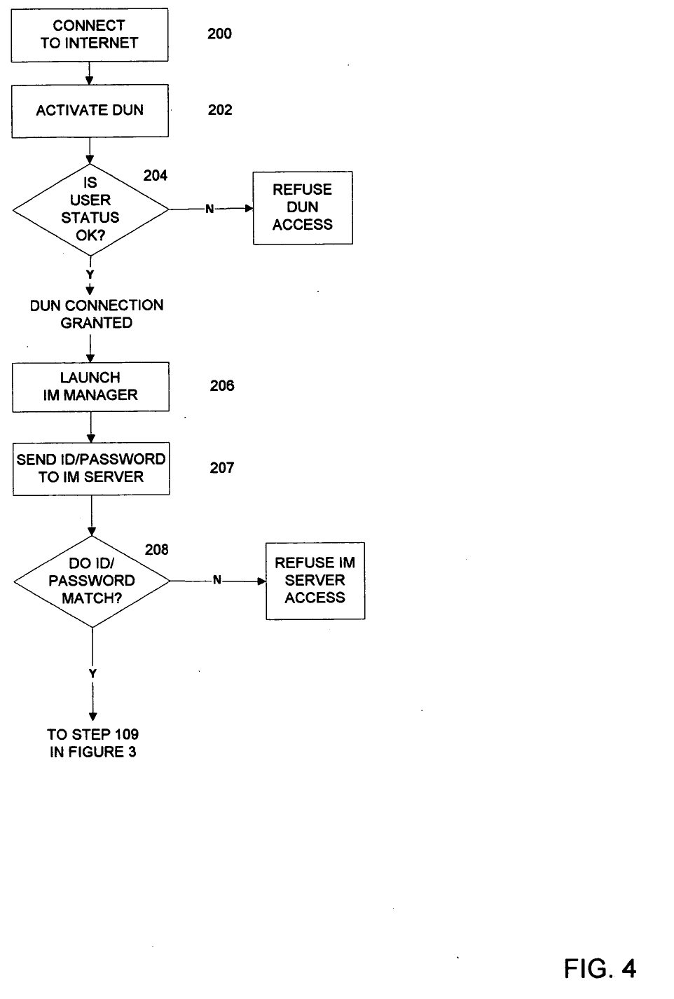

The flow chart of FIG. 4 with steps 200-208 describes the initial phase for the open Web implementation of FIG. 1. In step 200 Bill issues a command to his Pc 10 to establish a connection to the Internet 12. In response, in step 202 the PC 10 activates the DUN component 32 that attempts to connect to the SP 14 using a standard protocol such as PPP. In order to gain access, the DUN component 32 sends the user's ID and password to the SP 14's authorization database 42 (step 204). The authorization database 42 checks if Bill is a current and valid user of the SP and verifies the user ID and password. If the user ID and password are correct and Bill's account is active, the DUN connection is verified and Bill will have access to the Internet 12 through the SP 14. If for any reason Bill's status is unacceptable, access to the Internet 12 through the SP 14 is refused.

If Bill's is granted access to the internet 12 through the SP 14, in step 206 Bill launches the IM manager 34 and enters his user ID and password for the instant messaging SP 23 into the IM manager 34. In order to gain access to the instant messaging SP 23, in step 207 the IM manager 34 sends the user's system server ID and password to the IM server 30's authorization database 29 via the Internet 12 (step 208). The authorization database 29 verifies the user's system server II) and password. If the user's system server ID and password are correct, the connection to the IM server 30 is verified and Bill will have access to the IM server 30 via the Internet 12. If for any reason Bill's status is unacceptable, the access to the IM server 30 is refused.

The remainder of the operation of the open Web implementation of the system is identical to the closed network implementation described above, continuing with step 109.

As mentioned above, when he is in contact with Ted, Bill sees in message area 58 the messages he sent to Ted and the messages sent back by Ted to Bill as part of the instant messaging process. Message area 58 may be part of window 50 or may exist in a separate window.

Each time a friend of Bill's gets on or signs off of that friend's SP, the IM server 30 is notified and in turn updates the active friends list for each corresponding user and sends a message to SP 14 to update Bill's active friend list as well. Therefore, while he is exchanging messages with Ted, Bill is aware of his other active friends, Rhoda and Bob, and they are aware that he is active as well. At any time, Bill can ask for contact with his other friends, and his friends can initiate a contact with Bill. in this manner, Bill can participate in several IM exchanges at once. In FIG. 1 Bill can exchange instant messages with Ted and Rhoda, and Ted and Rhoda can exchange messages with Bill. When Bill talks to Ted, their messages appear in the message area 58. If Bill wants to talk to Rhoda, he clicks on her name and communication is established between them.

When Bill is talking to Ted, their conversation appears in message area 58 for Ted. If he starts talking to Rhoda, the messages to and from Ted disappear from message area 58 and are replaced by messages exchanged with Rhoda.

If he desires, he can also add a friend to the exchange with Ted, for example by right-clicking on Rhoda's name to generate a three-way conference exchange. In this instance the messages to and from each of the three participants appear in area 58. While two or three-way message exchanges take place, if any other friend wants to establish contact with Bill, he or she sends a message as described above, and his or her name changes color on window 50 to indicate the same.

Similarly, if Bill is performing some tasks on the Internet and has closed window 50, a friend can still initiate a request for contact and a message or a window is presented to Bill to indicate this event.

Obviously numerous modifications may be made to this invention without departing from its scope as defined in the appended claims.

1. A communication system, the system comprising:
a group of servers sharing user data, some of the servers capable of enabling a user to communicate with instant messaging capability, some of the servers capable of enabling a user to communicate with Internet telephone capability, to enable communication between a plurality of users by using one of said capabilities.
